(19) United States
(12) Patent Application Publication
(10) Pub. No.: US 2002/0038160 A1
(43) Pub. Date: Mar. 28, 2002

(54) Process and apparatus for preparing a composition of matter utilizing a side stream ultrasonic device

(76) Inventors: Shawn J. Maynard, Angleton, TX (US); Marcos Franca, Lake Jackson, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/877,161

(22) Filed: Jun. 8, 2001

Related U.S. Application Data
(60) Provisional application No. 60/211,736, filed on Jun. 15, 2000.

(51) Int. Cl. G06F 19/00

(52) U.S. Cl. 700/108; 700/269; 700/109; 702/28

(57) ABSTRACT

The properties of a resinous material product are controlled in a manufacturing system by online process parameter monitoring and control. The online monitoring and control incorporates an in-situ measurement system that can monitor product in the process by use of a side stream ultrasonic device. The side stream device advantageously provides online real-time measures of the product's acoustical properties (e.g. velocity, attenuation) under conditions that are independent of process-stream conditions. The side stream device controls the product temperature, pressure, and flow rate while inside the side stream device and the velocity and attenuation are measured under these predetermined temperature, pressure, and flow rate conditions. The acoustical properties (e.g. velocity, attenuation) of the product, are used to predict the properties of the product, and provides the process control system with analysis of the acoustical properties using derived relationships between the physical properties of the product and the acoustical properties. Differences between the predicted and desired product properties are used to control process parameters. The process can be used for a variety of chemical process plants.

### BACKGROUND OF THE INVENTION

This application claims the benefit of U.S. Provisional Application No. 60/211,736, filed Jun. 15, 2000.

This invention relates to a chemical plant and to a process and apparatus for controlling chemical processes in a chemical plant. More specifically, the present invention relates to a process and apparatus for controlling the reaction process of a composition of matter such as a solid epoxy resin product, utilizing a side stream sample of the product stream and a side stream ultrasonic measuring device. The reaction process is controlled, for example by controlling certain parameters such as epoxy equivalent weight, molecular weight, molecular weight distribution, or viscosity of the solid epoxy resin product.

A prominent method for controlling the process of polymerizing monomers or oligomers into higher oligomers or polymers involves sampling and off-line measuring polymer properties, such as epoxy equivalent weight, phenolic OH, or viscosity. These off-line measurement results, in combination or separately, are then used as the variables by which the entire process is controlled.

These off-line measurements are time consuming, expensive, and require material to be removed from the process. Process constraints may prohibit the sampling of material and the time requirements for obtaining the measurements are long enough to make controlling the process by these off-line methods problematic, expensive, and prohibit process automation.

Furthermore, there are certain desired product property measurements that can not be made under process conditions in the product stream, such as viscoelastic and thermodynamic measurements. Currently, these measurements are made off-line after the product has been cooled and the measurements are performed under specific sample temperature conditions, where the sample may be heated to a specific isothermal temperature or the sample may be heated at a specific rate from one temperature to another. In many cases, prior to these measurements being made the product will have been reformed into shapes acceptable for the specific measuring device, for example by compression molding machines. These tests are time consuming and expensive, requiring in many cases the product to be quarantined until test results are obtained. The results of the tests qualify the material as good or bad. However, the production of bad product typically can not be changed because of the time involved in generating the product property data prohibits an active feedback to the process control loop.

A need exists for an on-line technology that enables process automation by providing real-time, efficient, and precise polymer measurements of the product independent of processing conditions, such as temperature, that can be used as process control parameters.

Repetitious sampling and analytical measurements applied to a chemical production process present several significant potential problems.

First, there is inherent danger of removing a sample from a hot process stream, especially when the stream is viscous as in a polymer-forming process. Large insulated valves must be opened to allow material to flow into a small sample container. It is not uncommon for sampling ports in polymer lines to become partially plugged, causing the hot material to be unpredictably expelled from the opening.

Second, the procedure of removing a sample may alter the sample constitution. For example, the material removed from the line may only be partially converted and continue to react in the sample container after it is removed from the line. Furthermore, as the sampled material is viscous, it clings to the sample port valve, which may cause the current sample to be intermixed with remnants of previously acquired samples.

Third, the sampling and analysis procedure is time consuming. Many hundred or thousands of pounds of material can be produced in the time required to remove, prepare, and analyze a sample. The analytical data obtained from the sample is therefore of limited value for proactive process control.

Finally, because of the difficulties, cost, and hazards associated with sample removal, analytical sampling is typically infrequent. With minimal analytical data points, it is difficult to gain a statistically valid understanding of process variations or to make proper control adjustments to the process.

A preferred analysis method would monitor the material as it is being produced. Such a method would reduce the need to remove samples from the production environment, diminish the safety concerns, and facilitate more frequent and faster measurements.

There are, however, challenging obstacles that prevent most analytical techniques from providing in situ, on-line chemical constitution information in a process environment. First, the analytical method must be capable of accurately determining the desired properties with sufficient precision. Second, the analytical instrument must either be capable of withstanding the physical environment of a processing area or must be capable of sensing the desired composition properties from a remote location. Third, the interface of the instrumentation with the process must be able to survive the harsh pressure and temperature environment found inside the chemical process lines. Fourth, turbidity, bubbles and other common processing phenomena must not disturb the analytical measurements.

It is therefore desired to provide a process and apparatus that will overcome all of the above obstacles of the prior art methods and apparatuses.

### SUMMARY OF THE INVENTION

One aspect of the present invention is directed to a process for online monitoring and control of a process plant having a plurality of steps producing a product with a property P having a desired value D including (a) providing a side stream flow of the product to be measured, (b) online measuring at least one property P of the product by propagating an ultrasonic wave through said side stream product, (c) comparing the product property P to a desired predetermined property D, and (d) in view of the result of the measurement made in step (b) and the comparison made in step (c), controlling the preparation of the product by controlling certain process parameters.

Another aspect of the present invention is directed to an apparatus for online monitoring and control of a process plant having a plurality of steps producing a product with a property P having a desired value D including (a) a means for providing a side stream of the product to be measured, (b) an ultrasonic means adapted for propagating an ultrasonic wave through said side stream product and for online measuring at least one property P of the side stream product, (c) a means for comparing the product property P to a desired predetermined property D, and (d) a means for controlling the preparation of the product by controlling certain process parameters based on measurement data made by the ultrasonic means of (b) and comparison data made by the comparison means of (c).

Still another aspect of the present invention is directed to a process for preparing a composition of matter comprising the steps of:

(a) feeding one or more components of a composition of matter into a continuous reactor,

(b) preparing a composition of matter from the one or more components in the reactor,

(c) providing a side stream flow of the composition of matter product to be measured,

(d) measuring at least one property of the composition of matter by propagating an ultrasonic wave through said side stream of composition of matter, and

(e) in view of the result of the measurement made in step (d), controlling the preparation of the composition of matter within the reactor.

Yet another aspect of the present invention is directed to an apparatus for preparing a composition of matter comprising:

(a) a means for feeding one or more components of a composition of matter into a continuous reactor,

(b) a continuous reactor for preparing a composition of matter from the one or more components in the reactor,

(c) a means for providing a side stream of the composition of matter,

(d) an ultrasonic wave means for measuring at least one property of the side stream of the composition of matter by propagating an ultrasonic wave through said side stream of the composition of matter, and

(e) a means for controlling the preparation of the composition of matter within the reactor based on the result of the measurement made by the ultrasonic wave means of (d).

### DESCRIPTION OF THE DRAWINGS

FIG. 1 is a simplified flow diagram of a plant for manufacturing a resinous material.

FIG. 2 is a schematic representation, partly in cross section, of one embodiment of the process and apparatus of the present invention, and in particular, illustrates a side stream ultrasonic analyzer system used in the process of the present invention.

### DETAILED DESCRIPTION OF THE PREFERRED EMBODIMENTS

In general, the process of the present invention comprises an online monitoring and control process for a chemical plant having a plurality of steps producing a product with a property P having a desired value D utilizing a side stream ultrasonic waves means for measuring a property P of the side stream product and then based on the measurement controlling certain parameters of the process to obtain the desired value D of the product.

Generally, the process of the present invention is directed to controlling a reaction process for producing a product. The product may be any chemical product and preferably is a resinous material; and more preferably, the resinous material is a polymer resin.

The polymer resin useful in the present invention is preferably prepared by polymerizing one or more monomers and/or oligomers to form the polymer. As will be described below with reference to the Figures, the polymer resin is preferably prepared in a continuous reactor extruder.

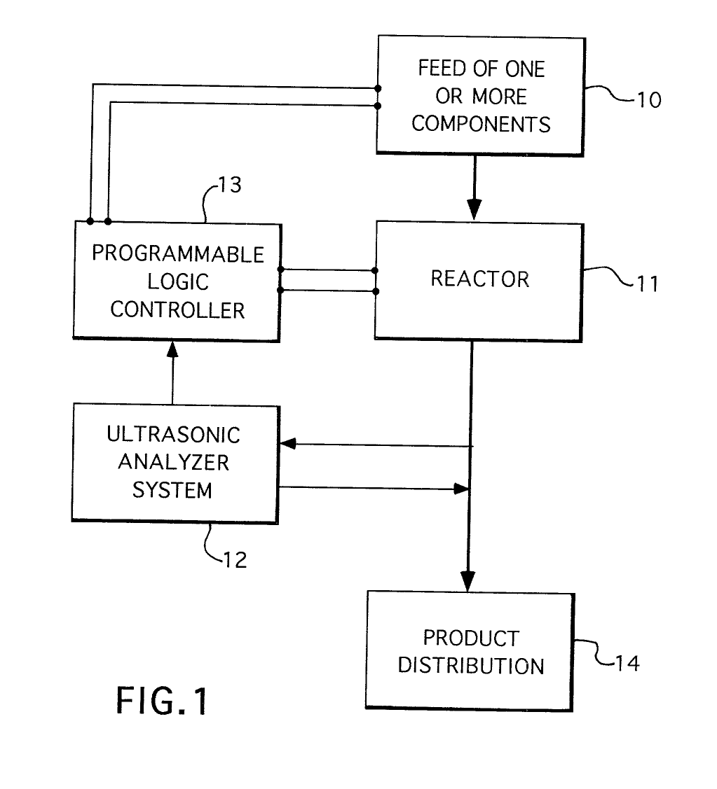

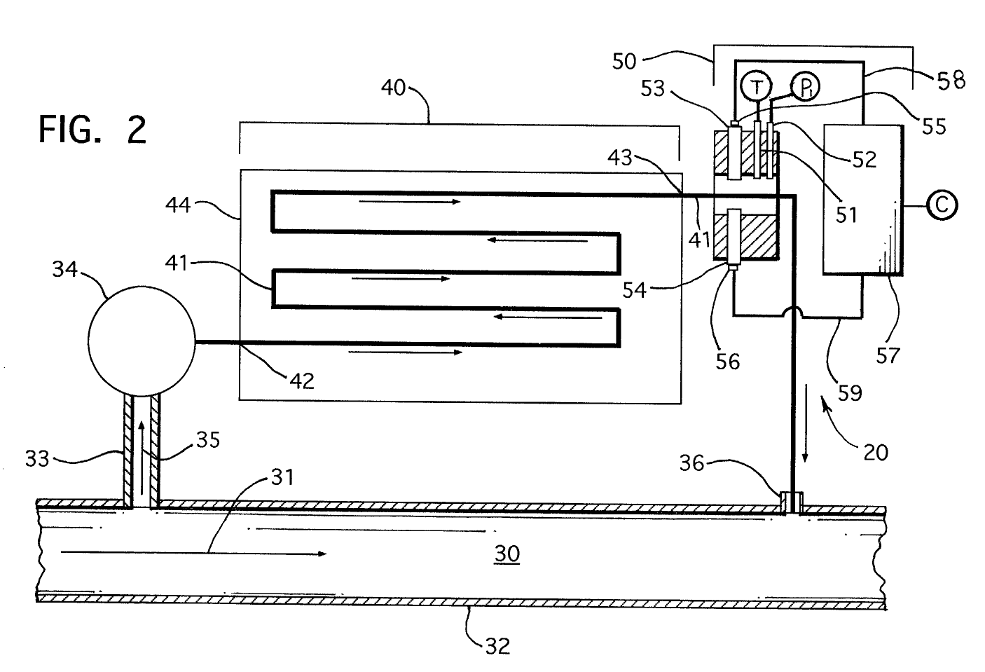

The present invention is best understood by reference to the accompanying FIGS. 1 and 2 illustrating the preferred embodiments of the present invention.

FIG. 1 illustrates one embodiment of the present invention and shows a simplified flow chart of a manufacturing process for the production of a resinous product such as an epoxy resinous product. With reference to FIG. 1, a resinous product, such as an epoxy resin, is typically manufactured by reacting epoxy monomers or oligomers to higher oligomers or polymers by action of a nucleophilic agent.

The process, shown in FIG. 1, is typically performed by blending or mixing a feed of one or more components such as epoxy monomers or oligomers with a nucleophic agent, a catalyst and, optionally, other additives or chain terminating agents in a mixing vessel or reactor 11. The mixture is typically heated in the reactor 11 and allowed to react for a period of time, until the desired product properties are achieved. The final properties of the product are measured by taking a side stream of the product stream utilizing a side stream ultrasonic analyzer system 12 and programmable logic controller 13. Preferably, the product may be purified and/or conditioned before measurement. Then the product may be either delivered to another process for further modification, or transformed into a form suitable for final distribution and sale as shown in product distribution means 14.

The final product properties are compared to the desired product properties to adjust product parameters in 13, as illustrated in FIG. 1, with a control loop in order to maintain the desired product properties. Also, the final product property measurements may be stored for statistical quality control records.

In operation, the ultrasonic control means apparatus indicated as numeral 12 in FIG. 1 (also generally indicated as numeral 20 in FIG. 2) propagates ultrasonic pulses through a product that is located between two surfaces in a direction normal to the flow. The ultrasonic pulses have duration such as to prevent successive echoes from overlapping with one another while reverberating between the two surfaces. The surface that the sound emanates from initially is the transmitter and the other surface is the receiver. The ultrasonic sound propagates from the transmission surface through the product and into the receiver surface, generating the through transmission signal (A₀). The first echo signal (A₁) is generated when the sound reflects off the receiver surface back into the product, reflecting off the transmission surface back into the product, and into the receiver surface.

Depending on the product, this echo or reverberation process may continue, generating successive echo signals (A₂, A₃. . . ). The delay time between two successive signals is continuously monitored to provide output signals representative of the product ultrasonic velocity. The amplitude difference between two successive signals is continuously monitored to provide output signals representative of the product ultrasonic attenuation. At the same time the temperature and pressure of the product is continuously monitored to provide output signals representative of the product temperature and pressure. These output signals are processed as a function of time to generate quantitative information relating to the product properties, P. This product property is compared to the desired property, D, to control process parameters.

FIG. 2 illustrates an ultrasonic side stream apparatus 20 useful in the present invention for online monitoring of a flow stream in a manner that enables a prediction of the properties of the finished product independent of processing conditions. The ultrasonic side stream apparatus 20 of the present invention provides for the diversion of product from the main process stream to provide online monitoring of a flow stream in a manner that enables a prediction of the viscoelastic, thermodynamic properties, epoxy equivalent weight, molecular weight, molecular weight distribution, viscosity, or melt index of the product. This prediction is, in turn, used to manipulate the inputs and the operating conditions of the process equipment to obtain finished products with the desired properties.

With reference to FIG. 2, there is shown an ultrasonic side stream device, generally indicated by numeral 20, coupled to a process flow stream 30 flowing in the direction indicated in arrow 31 in conduit 32. The device 20 comprises a sampling port 33, a gear pump 34, a product-conditioning zone, generally indicated by numeral 40, and an ultrasonic measurement cell, generally indicated by numeral 50. The gear pump 34 provides consistent precision flow rates and pressure; and the product-conditioning zone 40 delivers product to the ultrasonic measurement cell 50 at a consistent temperature. The product temperature may be constant or a temperature ramp where the initial temperature, final temperature, and rate of temperature increase or decrease is predetermined for the type of measurements needing to be made. The product pressure may be constant or a pressure ramp where the initial pressure, final pressure, and rate of pressure increase or decrease is predetermined for the type of measurements needing to be made. The product flow rate may be constant or a flow rate ramp where the initial flow rate, final flow rate, and rate of flow increase or decrease is predetermined for the type of measurements needing to be made.

Again with reference to FIG. 2, one preferred embodiment of the ultrasonic measurement cell 50 of the present invention is described including a temperature measurement device 51, a pressure measurement device 52, a transmission buffer rod 53, a transmission ultrasonic transducer 55, a receiver buffer rod 54, a receiver ultrasonic transducer 56, and a ultrasonic analyzer assembly 57 with electrical leads 58 and 59.

In the preferred embodiment, the ultrasonic analyzer assembly 57 includes cables, a pulser, a receiver, a waveform digitizer, a signal processor, a data processor, and a process computer, not shown, which are well known to those skilled in the art.

In a typical application the pulser in the assembly 57 sends out an ultrasonic pulse to the transducer 55 where the electronic signal is transformed into a mechanical ultrasonic sound wave emanating from the transducer 55 and into the transmission buffer rod 53, traveling down the buffer rod 53 and into the product flow stream 35 in fluid passageway 41, where the sound wave is transmitted into the receiver buffer rod 54, and then transformed back into an electronic signal at the receiver ultrasonic transducer 56, where the electronic signal is transmitted back to the polymer analyzer system 57 on a receiver channel. This analog signal is received, digitized, processed, and results in velocity and attenuation measurements C.

In conduit 32, product 30 is shown flowing in the direction indicated by arrow 31. A portion of the product, indicated by arrow 35, flowing through the process stream 30 is diverted into the ultrasonic side stream device 20 through the sampling port 33 where the gear pump 34 forces the product portion 35 toward and through the product-conditioning zone 40. The section 40 is preferably a fluid passageway 41 having an inlet 42 and an outlet 43. The section 40 may also include a series of static mixers (not shown) inserted in the passageway 41 located inside of a temperature regulated housing 44. The side stream product portion 35 then passes from the outlet 43 to the ultrasonic measurement cell 50. In the cell 50, the side stream 35 passes between two buffer rods 53 and 54, after which the side stream product is returned back to the process stream 30 via another sampling port 36.

The ultrasonic side stream device 20 also includes a temperature-measuring device 51 that comprises a probe that monitors the temperature of the side stream product. The output of the temperature measurement device is a temperature measurement T of the side stream product temperature. The temperature measurement is used by the process computer, not shown, as described below.

The ultrasonic side stream device 20 also includes a pressure-measuring device 52 that comprises a probe that monitors the pressure of the side stream product. The output of the pressure measurement device is a pressure measurement P₁ of the side stream product pressure. The pressure measurement is used by the process computer, not shown, as described below.

The outputs C, T, and P₁ of the ultrasonic instrument assembly 20 are transmitted to a computer that analyzes the measurements, as discussed below, and predicts the product 30 properties that could be expect from the process. Difference between the predicted product properties, P, and the desired properties, D, of the product 30 are used to control the process parameters, also as discussed below.

The side stream device shown in FIG. 2 is for illustrative purpose only. Those knowledgeable in the art would recognize other measurements or designs could be incorporated in the device described above. These additional measurements or designs are intended to be within the scope of the present invention.

The ultrasonic side stream device 20 is generally mounted so as to monitor a side stream of a product flow stream, for example an epoxy resin. The device 20 may be disposed to divert a sample from the reactor itself or at any point downstream of the reactor 11. For example, the device 20 may be positioned so as to obtain a portion of the flow stream directly after the product exits the reactor 11. In another embodiment of the present invention, the mounting of the device may be done at the output of another step in the process, for example after a purification step in the process. The measurements using the side stream device 20 are used to determine, for example, the epoxy equivalent weight, molecular weight, molecular weight distribution, viscosity, or melt index of the epoxy product.

The components of the ultrasonic instrumentation assembly 50 including for example, the temperature measuring device 51, the pressure measuring device 52, buffer rods 53 and 54, ultrasonic transducers 55 and 56, and analyzer assembly 57, are not discussed in detail as these components would be familiar to those knowledgeable in the art.

As described above, the propagating sound wave can be transmitted or reflected, generating the signals of interest (A₁, A₂, A₃. . . ). These signals are amplified, digitized, and processed through a correlation procedure such as described and incorporated herein by reference William H. Press et al., in Numerical Recipes, pages 381-416, to obtain data comprising ultrasonic velocity and attenuation values measured simultaneously as a function of time.

The propagating sound wave can be transmitted or reflected, generating the signals of interest (A₁, A₂, A₃. . . ) from which the measurements of velocity and attenuation are made (A₂-A₁, A₃-A₂, etc.), as described in U.S. Pat. No. 5,433,112, incorporated by reference, particularly with reference to FIG. 2.

The delay time between two successive signals (A₂-A₁, A₃-A₂, etc.) is continuously monitored to provide output signals representative of the product ultrasonic velocity. The amplitude difference between two successive signals is continuously monitored to provide output signals representative of the product ultrasonic attenuation. These two acoustical measurements are for illustrative purpose only. Those knowledgeable in the art would recognize that other measurements could be also made using the signals described above. These additional measurements are intended to be within the scope of the present invention.

A reactor with an inlet and an outlet is preferably used for producing a polymer in the present invention. At least one or more reactant components are fed into the reactor from a feeding means. A reaction occurs within the reactor and the reaction in the reactor is controlled with an ultrasonic side stream control means 20. A product stream exits the reactor at the outlet of the reactor. The composition of matter prepared in the reactor, is generally a resinous material; and more specifically, the resinous material is a polymer resin. The resinous material useful in the present invention is prepared by using a continuous reactor 30. The continuous reactor 30 used for this purpose may be a pipe or tubular reactor, or an extruder. It is preferred to use an extruder. More than one such reactor may be used for the preparation of different resinous materials. Any number of reactors may be used in the present invention.

The polymer resin useful in the present invention is preferably prepared by polymerizing one or more monomers and/or oligomers in the continuous polymerization reactor to form the polymer. Typically, a catalyst may be added to the polymerization reaction mixture for the purpose of obtaining a specific type of resinous material, or a desired rate of conversion. The monomer(s), oligomer(s), and catalyst when desired, may, each separately or in groups of two or more, be fed to the polymerization reactor in one or more of the following forms: a liquid solution, a slurry, or a dry physical mixture.

The resinous material from which a composition is prepared may be virtually any polymer or copolymer. The resinous material need not have any particular molecular weight to be useful as a component in the composition. The resinous material may have repeating units ranging from at least two repeating units up to those resinous materials whose size is measured in the hundreds or thousands or repeating units. Particular resinous materials that may be used in the methods of the present invention include for example, epoxy resins, polyesters, urethanes, acrylics and others as set forth in U.S. Pat. No. 5,094,806 which is incorporated herein by reference.

The most preferred resinous materials useful in the present invention from among those listed above are epoxy resins and polyesters. Epoxy resins useful in the present invention, and materials from which epoxy resins may be prepared, are described in U.S. Pat. No. 4,612,156, which is incorporated herein by reference. Polyesters useful in the present invention, and materials from which polyesters may be prepared, are described in Volume 12 of Encyclopedia of Polymer Science and Engineering, pages 1-313 which pages are incorporated herein by reference. A most preferred resinous material prepared according to the present invention may be the reaction product of an epoxy resin and bisphenol A to form a higher oligomer or polymer.

In the production of a resinous material to be used in the present invention, various conditions or parameters have an effect on the course of the polymerization reaction. Typical examples of these conditions or parameters are as follows: the rate of feed to the reactor of the monomer(s) and/or oligomer(s); the temperature at which the reaction occurs; the length of time during which the reaction occurs; and the degree to which the reactants are mixed or agitated before or during the reaction. The rate of feed of monomer(s) and/or oligomer(s) can be influenced, for example, by valve adjustment on a pressured line. The temperature at which the reaction occurs can be influenced, for example, by the direct heating or cooling of the monomer(s) and/or oligomer(s) or to the reactor itself. The length of time during which the reaction occurs can be influenced, for example, by the size of the reactor, such as the length of a pipe, tube or extruder, or the speed at which the reactants move into and out of the reactor, such as may result from the particular speed or design of an extruder screw, or the introduction of a pressurized inert gas into a pipe or tube. The degree to which the reactants are mixed or agitated during the reaction can be influenced, for example, by the size, shape and speed of blades or other mixing elements, by the presence of a static mixing element in a pipe or tube, or the speed of the screw in an extruder.

The quality of the composition that may be prepared by the process of the present invention is improved if the properties of the resinous material are known and maintained at a desired level. Typical examples of resinous material properties that may be analyzed for this purpose are viscosity, melt index, melt flow rate, molecular weight, molecular weight distribution, equivalent weight, phenolic OH, conversion, blend composition, phase distribution, domain size, particle size, particle size distribution, melting point, viscoelastic properties (e.g. G′, G″, Tan Delta), glass transition temperature, density, specific gravity, and purity. For example, when an epoxy resin is used as a resinous material, it is desired that its viscosity be in the range of from about 1 to about 100,000 centipoise.

The analytical technique that is used to determine resinous material properties such as the foregoing include ultrasonic wave energy utilizing the ultrasonic side stream control means 20, shown in FIGS. 1 and 2, of the present invention.

Polymeric properties P such as those mentioned above may be maintained at a desired level by adjusting one or more of conditions or parameters that have an effect on the course of the polymerization reaction. Typical examples of such conditions or parameters are discussed above. To determine the manner and extent to which polymerization conditions should be adjusted, however, the analytical technique must first be performed to determine to what extent, if any, the polymeric property differs from the desired level.

A particularly advantageous method of using polymeric property data in connection with the adjustment of polymerization conditions is to perform the analysis needed to determine the polymeric properties of interest while the polymerization reaction is in progress. This method involves performing the property analysis on polymer or copolymer that is actually inside the reactor.

In one embodiment, the required analytical instrument extracts a sample from inside the reactor such that the polymer or copolymer side stream sample passes through the side stream instrument for analysis as the reaction progresses in that vicinity of the reactor. It is also preferred to perform property analysis on a polymer prior to the point of its exit from the reactor or as the polymer exits the reactor.

After the polymeric property data has been obtained by analyzing the side stream as it relates to a polymer or copolymer that is inside the reactor, an adjustment in one or more conditions of the reaction may be made if necessary. Adjusting the conditions under which a polymer is prepared, in response to an analysis (as the polymer is being prepared) of the properties of the polymer resulting from those conditions, enables real-time control of the reaction by which the polymeric component or a blended composition is prepared.

The polymeric material needs to have specific physical and thermodynamic properties to be useful as a component in the composition. The reacting monomeric mixture as well as the polymeric material must be measured to achieve and maintain the physical and thermodynamic properties of the polymeric material. Sampling the material is a significant problem. This measurement could be made off-line by sampling the reacting monomeric mixture or polymeric material; however, this approach is less desirable than real-time on-line analysis of the reacting monomeric mixture and polymeric material. For example, off-line analyses are less accurate because the material continues to react after removal from the mixer. Furthermore, the time it takes to perform the off-line analysis, is time that the process could potentially be operating outside of its “normal” range. On-line measurements of physical and thermodynamic properties are not burdened by these issues and real-time analysis eliminates the time lag between measurement observation and process response.

The on-line measurement of the present invention is preferentially made by use of ultrasonic sound waves after propagation through a side stream of the monomeric mixture or polymeric material. For example, acoustic sound waves are propagated through the monomers, monomeric mixture, or polymeric material where the acoustic characteristics (velocity, attenuation, amplitude, frequency, or phase shift) are altered by interaction with such material. This change in acoustic character is related to the physical and thermodynamic properties of the monomers, reacting monomeric mixture, higher oligomers, or polymeric material and gives rise to the measurement of such properties. By using standard materials, mathematical algorithms are derived that describe the interaction between the acoustic parameters and the product properties P. The mathematical algorithm is used to derive the product properties P by measuring the acoustic properties. Furthermore, additional algorithms can be used to derive other product properties P′ from product properties P.

These physical and thermodynamic property measurements P or P′ constitute the process output of the ultrasonic device. These properties are achieved and maintained by means of controlling key process variables by using the process output from the ultrasonic device. The output of the ultrasonic device is used by the process control code, which decides which process variable(s) are altered and to what degree in order to maintain the physical and thermodynamic properties of the reacting monomeric mixture or polymeric material. For example, appropriate adjustments could be made to the mixing rate, reactor pressure, reactor temperature, monomer and/or catalyst feed temperatures, monomer and/or catalyst feed ratios, mixer design, or reactor design.

For example, when an epoxy resin is being made in a reactor, it is helpful to measure one or more properties such as viscosity, molecular weight or epoxy equivalent weight. If the property measured does not have a value within the desired range, an adjustment may be made to one or more of the conditions of polymerization such as the rate of feed of the reactants, the temperature at which the reaction occurs, or the length of the duration of the reaction. When the reaction is being conducted in a pipe or tubular reactor or an extruder, the length of the duration of the reaction may be controlled by regulating the force with which the reactants are moved through the reactor, for example the force with which originally fed to the reactor or the speed of the screw in an extruder.

When one or more properties of an epoxy resin such as viscosity, molecular weight, epoxy equivalent weight or content of contaminants is being measured, it is particularly useful to perform such measurements by the propagation of ultrasonic pulse through the epoxy resin. Methods for the use of ultrasonic pulses to measure the properties of polymers are described in U.S. Pat. Nos. 4,754,645 and 5,433,112; each of which is incorporated by reference in its entirety into this application.

In another embodiment of the present invention, a composition comprising a mixture or a blend of two or more components may be prepared. For example, the resinous material may be prepared in one reactor, as one component of the final composition, and then the resinous material may be combined with one or more other resinous materials or with one or more other ingredients or additives. The resinous material prepared in the reactor may be continuously conveyed from the reactor to a mixer through a connection between the reactor and the mixer.

If more than one reactor is used, a connection is established between each reactor and the mixer. Optionally, a blended or compounded composition may be prepared by feeding the exit product stream from several reactors connected directly to a mixer in which the blended or compounded composition is prepared. A pipe or tubular joint is suitable for use as the means of making the connection between the reactor and the mixer.

The preferred type of mixer used in the present invention, is an extruder, particularly a twin-screw extruder but other types of mixers such as co-kneaders may be used as well.

As aforementioned, a composition may be prepared by compounding the resinous material with other components of a composition. The other components of the composition includes a number of other ingredients which may also include another resinous material, such as an epoxy or a polyester, or other resinous materials listed above. The remaining components of the composition may also include ingredients such as conventional additives for example hardeners for an epoxy resin (e.g. dicyandiamide), fillers, pigments, stabilizers and other additives well known in the art. Other additives as ingredients for the composition of the present invention are disclosed in U.S. Pat. No. 5,416,148 which is incorporated herein by reference. Such additives may be incorporated as a liquid into the composition. After mixing the composition in the mixer, the composition is recovered in a form suitable for handling, such as in the form of a flake or pellet.

Other materials which can be measured according to the present invention may include for example, polyurethanes, epoxy thermoplastics such as PHAE and PHEE, liquid epoxy resins such as DER*331 and DER 383 as well as other epoxy resins sold commercially by The Dow Chemical Company, additives such as flow modifiers, and unreacted and nonreactive blends.

### EXAMPLE 1

A. Apparatus

The apparatus used in this Example 1 included a continuous reactor. The continuous reactor was a Krupp Werner-Pfleiderer ZSK-30 intermeshing, co-rotating, twin screw extruder. The reactor extruder barrel had an internal diameter of 30 mm with a length to diameter ratio of 46.7. The barrel consisted of 9-barrel sections. A temperature controller was used to control the barrel temperature of each section. Attached to barrel 9 of the reactor extruder was a gear pump and a divert valve. The ultrasonic analyzer system 12 in FIGS. 1 and 20 in FIG. 2 and described above was attached to the divert valve.

B. Process

Liquid epoxy resin based on the diglycidyl ether of bisphenol A and p,p′-bisphenol A were rate added to zone 1 of the reactive extruder. A phosphonium catalyst was dissolved in the liquid epoxy resin feed. The mixture had the following ratios for the epoxy resin: 76.0 wt %, bisphenol A: 24.0 wt %, and catalyst: 550 parts per million.

The mixture was then fed to the 30-mm Krupp, Werner & Pfleiderer reactor extruder as described above. The conditions of the Krupp Werner & Pfleiderer extruder were: 347° F. (175° C.) on barrel 1, 374° F. (190° C.) on barrels 2 to 3, 347° F. (175° C.) on barrels 4 to 6, and 464° F. (240° C.) on barrels 7 to 9. The processing conditions (feeding ratios of liquid epoxy resin, p,p′-bisphenol A, and catalyst) were varied to produce a series of resinous materials while characterizing the extrudate with the ultrasonic analyzer system described above.

For each processing condition extrudate was sampled and characterized by standard titration method (ASTM D 1652) for epoxide equivalent weight. The experimental ratios used varied the epoxy equivalent weight from 495 to 2,275. The ultrasonic analyzer system, shown in FIGS. 1 and 2, produced results C (velocity, attenuation, temperature, and pressure measurements) data sets obtained at a predetermined set rate of data acquisitions. These data were used to calculate the epoxy equivalent weight of the extrudate. The known value of the epoxy equivalent weight, determined by titration, are compared to the predicted epoxy equivalent weight values using the ultrasonic analyzer system in Table 1. The predicted values from the ultrasonic analyzer correspond almost identically to the known values obtained by titration. (Slope=0.9955 and correlation coefficient of 0.9976) The average absolute difference between the ultrasonic predicted value and the titration value was 21.6 EEW with a standard deviation of 12.1 EEW. The average relative difference between the ultrasonic predicted value and the titration value was 1.80% that was calculated as shown below;

$$Average Relative Difference = 1.80 \% = ( \frac{[ Ultrasonic - Titration ]}{Titration} * 100 )$$

with a standard deviation of 1.38%.

TABLE 1
Comparison of a Measured Epoxy Equivalent Weight and Predicted
Epoxy Equivalent Weight of Several Epoxy Resins

| Titration EEW | Ultrasonic EEW | Difference (EEW) | Difference (%) |
|---|---|---|---|
| 495.00 | 528.05 | 33.05 | 6.26 |
| 496.04 | 526.21 | 30.17 | 5.73 |
| 497.14 | 527.76 | 30.62 | 5.80 |
| 498.16 | 528.07 | 29.91 | 5.66 |
| 498.26 | 527.33 | 29.07 | 5.51 |
| 513.19 | 537.85 | 24.66 | 4.59 |
| 589.72 | 597.88 | 8.16 | 1.36 |
| 686.75 | 695.05 | 8.30 | 1.19 |
| 709.14 | 707.99 | 1.15 | 0.16 |
| 711.36 | 713.89 | 2.53 | 0.35 |
| 711.48 | 709.08 | 2.40 | 0.34 |
| 711.62 | 709.05 | 2.57 | 0.36 |
| 711.99 | 708.13 | 3.86 | 0.54 |
| 713.84 | 715.55 | 1.71 | 0.24 |
| 715.66 | 711.78 | 3.88 | 0.55 |
| 716.13 | 719.18 | 3.05 | 0.42 |
| 733.82 | 752.68 | 18.86 | 2.51 |
| 751.86 | 773.38 | 21.52 | 2.78 |
| 754.78 | 743.55 | 11.23 | 1.51 |
| 824.35 | 801.34 | 23.01 | 2.87 |
| 888.35 | 863.35 | 25.00 | 2.90 |
| 917.55 | 903.18 | 14.37 | 1.59 |
| 918.66 | 904.79 | 13.87 | 1.53 |
| 923.28 | 906.67 | 16.61 | 1.83 |
| 923.42 | 896.91 | 26.51 | 2.96 |
| 928.00 | 917.70 | 10.30 | 1.12 |
| 929.42 | 891.54 | 37.88 | 4.25 |
| 942.97 | 939.94 | 3.03 | 0.32 |
| 948.88 | 983.84 | 34.96 | 3.55 |
| 965.48 | 950.55 | 14.93 | 1.57 |
| 994.39 | 1021.42 | 27.03 | 2.65 |
| 1019.88 | 1028.89 | 9.01 | 0.88 |
| 1070.95 | 1032.88 | 38.07 | 3.69 |
| 1073.85 | 1032.30 | 41.55 | 4.03 |
| 1099.13 | 1086.58 | 12.55 | 1.15 |
| 1103.35 | 1089.14 | 14.21 | 1.31 |
| 1104.74 | 1090.76 | 13.98 | 1.28 |
| 1105.78 | 1091.31 | 14.47 | 1.33 |
| 1107.52 | 1088.57 | 18.95 | 1.74 |
| 1116.09 | 1095.21 | 20.88 | 1.91 |
| 1350.22 | 1323.43 | 26.79 | 2.02 |
| 1371.80 | 1394.16 | 22.36 | 1.60 |
| 1455.24 | 1446.39 | 8.85 | 0.61 |
| 1464.46 | 1458.94 | 5.52 | 0.38 |
| 1466.13 | 1445.28 | 20.85 | 1.44 |
| 1467.26 | 1433.93 | 33.33 | 2.32 |
| 1473.75 | 1465.08 | 8.67 | 0.59 |
| 1474.86 | 1451.13 | 23.73 | 1.64 |
| 1474.88 | 1447.29 | 27.59 | 1.91 |
| 1485.22 | 1472.36 | 12.86 | 0.87 |
| 1510.06 | 1486.13 | 23.93 | 1.61 |
| 1563.44 | 1567.73 | 4.29 | 0.27 |
| 1567.34 | 1540.96 | 26.38 | 1.71 |
| 1568.71 | 1551.24 | 17.47 | 1.13 |
| 1569.20 | 1544.12 | 25.08 | 1.62 |
| 1569.50 | 1537.03 | 32.47 | 2.11 |
| 1575.25 | 1541.47 | 33.78 | 2.19 |
| 1580.44 | 1547.12 | 33.32 | 2.15 |
| 1581.69 | 1551.63 | 30.06 | 1.94 |
| 1582.29 | 1577.72 | 4.57 | 0.29 |
| 1586.30 | 1554.39 | 31.91 | 2.05 |
| 1587.04 | 1561.61 | 25.43 | 1.63 |
| 1591.32 | 1557.15 | 34.17 | 2.19 |
| 1613.97 | 1614.01 | 0.04 | 0.00 |
| 1616.42 | 1595.91 | 20.51 | 1.29 |
| 1619.54 | 1609.89 | 9.65 | 0.60 |
| 1628.30 | 1610.01 | 18.29 | 1.14 |
| 1630.85 | 1604.36 | 26.49 | 1.65 |
| 1638.30 | 1616.39 | 21.91 | 1.36 |
| 1655.96 | 1695.97 | 40.01 | 2.36 |
| 1661.88 | 1610.75 | 51.13 | 3.17 |
| 1690.54 | 1661.68 | 28.86 | 1.74 |
| 1695.83 | 1710.90 | 15.07 | 0.88 |
| 1856.06 | 1878.94 | 22.88 | 1.22 |
| 1873.10 | 1919.22 | 46.12 | 2.40 |
| 1875.79 | 1909.24 | 33.45 | 1.75 |
| 1880.89 | 1898.50 | 17.61 | 0.93 |
| 1888.44 | 1918.80 | 30.36 | 1.58 |
| 1895.06 | 1922.32 | 27.26 | 1.42 |
| 1900.27 | 1944.07 | 43.80 | 2.25 |
| 1903.44 | 1933.56 | 30.12 | 1.56 |
| 1911.61 | 1939.58 | 27.97 | 1.44 |
| 1913.45 | 1936.68 | 23.23 | 1.20 |
| 1914.88 | 1941.41 | 26.53 | 1.37 |
| 1923.35 | 1952.18 | 28.83 | 1.48 |
| 1974.35 | 1997.50 | 23.15 | 1.16 |
| 2006.70 | 2033.29 | 26.59 | 1.31 |
| 2008.30 | 2022.71 | 14.41 | 0.71 |
| 2037.37 | 2032.53 | 4.84 | 0.24 |
| 2111.00 | 2052.68 | 58.32 | 2.84 |
| 2172.36 | 2152.61 | 19.75 | 0.92 |
| 2255.18 | 2225.56 | 29.62 | 1.33 |
| 2267.53 | 2234.76 | 32.77 | 1.47 |
| 2275.68 | 2254.39 | 21.29 | 0.94 |

What is claimed is:

1. A process for online monitoring and control of a process plant having a plurality of steps producing a product with a property P having a desired value D, comprising the steps of:
(a) providing a side stream flow of the product to be measured,
(b) online measuring at least one property P of the product by propagating an ultrasonic wave through said side stream product, and
(c) in view of the result of the measurement made in step (b) controlling the preparation of the product by controlling certain process parameters.

2. The process of claim 1 including the step of comparing the product property P to a desired predetermined property D.

3. The process of claim 1 wherein the product property P is derived by (i) measuring the ultrasonic properties such as velocity, temperature, pressure, and attenuation; and (ii) correlating these properties to the product properties by mathematical algorithms which were derived by correlation between standard materials and ultrasonic parameters.

4. The process of claim 3 wherein a product property P′ is derived by correlating the measured product property P by mathematical algorithms which were derived by correlation between standard materials for product properties P′ and measured product property P.

5. The process of claim 3 wherein the product property P is derived by controlling the flow rate, pressure or temperature of the side stream.

6. A process for preparing a composition of matter comprising the steps of:
(a) feeding one or more components of a composition of matter into a continuous reactor,
(b) preparing a composition of matter from the one or more components in the reactor,
(c) providing a side stream flow of the composition of matter product to be measured,
(d) measuring at least one property of the composition of matter by propagating an ultrasonic wave through said side stream of composition of matter, and
(e) in view of the result of the measurement made in step (d), controlling the preparation of the composition of matter within the reactor.

7. The process of claim 6 wherein the side stream in step (c) is provided at a consistent flow rate, pressure and temperature or at a controlled rate of change of flow rate, pressure and temperature to an ultrasonic measuring means.

8. The process of claim 6 wherein the reactor is an extruder.

9. The process of claim 6 wherein the composition of matter is a resinous material.

10. The process of claim 9 wherein the resinous material is a polymer.

11. The process of claim 10 wherein the polymer is an epoxy.

12. A process for preparing a polymer comprising the steps of:
(a) feeding one or more monomers and/or oligomers into a continuous reactor,
(b) forming a polymer by polymerizing the one or more monomers and/or oligomers within the reactor,
(c) providing a side stream flow of the polymer,
(d) measuring at least one property of the polymer by propagating an ultrasonic wave through said side stream of polymer,
(e) in view of the result of the measurement made in step (d), adjusting and/or maintaining at least one condition that affects the polymerization of the one or more monomer(s) and/or oligomer(s) within the reactor so as to control the resultant polymer, and
(f) recovering from the reactor the polymer prepared after the adjustment and/or maintenance of the condition performed in step (e).

13. The process of claim 12 therein the reactor is an extruder.

14. The process of claim 12 wherein the measurement step (d) is carried out during the polymerization of the one or more monomers and/or oligomers; and/or after the polymer is formed.

15. The process of claim 12 wherein the property measured in step (d) is at least one member selected from the group comprising viscosity, melt index, melt flow rate, molecular weight, molecular weight distribution, equivalent weight, phenolic OH, conversion, blend composition, additive composition, morphological composition, phase distribution, domain size, particle size, particle size distribution, melting point, viscoelastic properties (for example,. G′, G″, Tan Delta), glass transition temperature, density, specific gravity, thermodynamic constants, and purity.

16. The process of claim 12 wherein the condition of the polymerization that is adjusted and/or maintained is at least one member selected from the group comprising: rate of feed of the monomer(s) and/or oligomer(s), temperature of monomer and/or oligomer feeds, catalyst concentration, stoichiometry, reaction temperature, heating rate of the extruder, cooling rate of the extruder, screw speed, extruder size, extruder throughput, screw design, resident time distribution, rate of mixing, degree of mixing, rate of reaction and length of reaction time.

17. The process of claim 15 wherein the property measured is viscosity.

18. The process of claim 12 including the step of determining the presence of a contaminant in the polymer prepared in step (b) by ultrasonic waves.

19. The process of claim 18 wherein the extent of the presence of the contaminant in the polymer is quantified by ultrasonic waves.

20. The process of claim 12 further comprising the step of feeding a catalyst to the reactor.

21. The process of claim 12 including the steps of:
(g) conveying polymer from the reactor to a mixer, through a connection between the reactor and the mixer, polymer(s) prepared after the adjustment and/or maintenance of the condition performed in step (e), and
(h) preparing a composition of matter by admixing, in the mixer, one or more other components of the composition of matter with the polymer(s) prepared in step (b).

22. The process of claim 21 wherein the mixer is an extruder.

23. An apparatus for online monitoring and control of a process plant having a plurality of steps producing a product with a property P having a desired value D comprising:
(a) a means for providing a side stream of the product,
(b) an ultrasonic means for online measuring at least one property P of the product by propagating an ultrasonic wave through said side stream product,
(c) a means for comparing the product property P to a desired predetermined property D, and
(d) a means for controlling the preparation of the product by controlling certain process parameters based on the in view of the result of the measurement made by the ultrasonic means in (a) and the comparison made by the comparison means in (b).

24. An apparatus for preparing a composition of matter comprising:
(a) a means for feeding one or more components of a composition of matter into a continuous reactor,
(b) a continuous reactor for preparing a composition of matter from the one or more components fed to in the reactor,
(c) a means for providing a side stream of the composition of matter,
(d) an ultrasonic wave measuring means for measuring at least one property of the side stream of the composition of matter, and
(e) a means for controlling the preparation of the composition of matter within the reactor based on the result obtained by the measurement means in (d).

25. An apparatus for preparing a polymer comprising:
(a) a means for feeding one or more monomers and/or oligomers into a continuous reactor,
(b) a continuous reactor for forming a polymer by polymerizing the one or more monomers and/or oligomers,
(c) a means for providing a side stream of the polymer,
(d) an ultrasonic wave measuring means adapted for propagating ultrasonic waves through the side stream of the polymer and for measuring at least one property of the side stream,
(e) a means for adjusting and/or maintaining at least one condition that affects the polymerization of the one or more monomer(s) and/or oligomer(s) within the reactor based on the result obtained by the measurement means in (d), and
(f) a means for recovering from the reactor the polymer prepared after the adjustment and/or maintenance of condition is made by the means of (e).

26. The apparatus of claim 25 wherein the reactor is an extruder.

27. The apparatus of claim 25 wherein the measurement means of (d) is adapted for measuring the at least one property of the polymer during the polymerization of the one or more monomers and/or oligomers; and/or after the polymer is formed.

28. The apparatus of claim 25 wherein the property measured is at least one member selected from the group comprising viscosity, melt index, melt flow rate, molecular weight, molecular weight distribution and equivalent weight.

29. The apparatus of claim 25 wherein the condition of the polymerization that is adjusted and/or maintained is at least one member selected from the group comprising: rate of feed of the monomer(s) and/or oligomer(s), catalyst concentration, stoichiometry, reaction temperature, rate of mixing, degree of mixing, rate of reaction and length of reaction time.

30. The apparatus of claim 20 including an ultrasonic wave measuring means for determining the presence of a contaminant in the polymer.

31. The apparatus of claim 30 wherein the ultrasonic wave measuring means is adapted for quantifying the presence of the contaminant in the polymer.

32. The apparatus of claim 29 further comprising a means for feeding a catalyst to the reactor.

33. An apparatus of claim 25 including:
(g) a mixer connected to the reactor, said mixer adapted for preparing the composition of matter by admixing, the polymer(s) prepared in the reactor with one or more other components of the composition of matter, and
(h) a means for conveying from the reactor to the mixer, through a connection between the reactor and the mixer, the polymer(s) prepared after the adjustment and/or maintenance of condition performed in (e).

34. The apparatus of claim 33 wherein the mixer is an extruder.
